(19) United States
(12) Patent Application Publication
(10) Pub. No.: US 2015/0100946 A1
(43) Pub. Date: Apr. 9, 2015

(54) USING MOCK DATA TO VALIDATE APPLICATIONS

(71) Applicants: Frank Brunswig, Heidelberg (DE); Jochen Saterdag, St. Leon-Rot (DE); Patrick Zimmer, Walldorf (DE)

(72) Inventors: Frank Brunswig, Heidelberg (DE); Jochen Saterdag, St. Leon-Rot (DE); Patrick Zimmer, Walldorf (DE)

(21) Appl. No.: 14/048,726

(22) Filed: Oct. 8, 2013

(51) Int. Cl. G06F 11/36

(52) U.S. Cl. CPC G06F 11/3664; G06F 11/368
USPC 717/124

(57) ABSTRACT

The disclosure generally describes computer-implemented methods, software, and systems for using mock application data to validate applications. A particular application to be validated is identified, wherein the particular application is generated via a user interface for generating new applications, and wherein the particular application is consistent with a data model used during the generation of the particular application. A set of stored mock application data associated with the particular application is identified. At least a portion of the identified set of mock application data is incorporated into a runtime version of the particular application. The particular application is executed using the incorporated set of mock application data in a validation environment.

### TECHNICAL FIELD

The present disclosure relates to computer-implemented methods, software, and systems for using mock application data during application testing and validation.

### BACKGROUND

New and existing applications, once they are developed, need to be tested and/or validated. Although the testing/validation can use productive data, it can be beneficial to use mock application data instead, as long as it is suitable for use.

### SUMMARY

The disclosure generally describes computer-implemented methods, software, and systems for using mock data to validate applications. As an example, a particular application to be validated is identified, wherein the particular application is generated via a user interface for generating new applications, and wherein the particular application is consistent with a data model used during the generation of the particular application. A set of stored mock application data associated with the particular application is identified. At least a portion of the identified set of mock application data is incorporated into a runtime version of the particular application. The particular application is executed using the incorporated set of mock application data in a validation environment.

The present disclosure relates to computer-implemented methods, software, and systems for providing instructions for presenting a list. One computer-implemented method includes: identifying a particular application to be validated, wherein the particular application is generated via a user interface for generating new applications, and wherein the particular application is consistent with a data model used during the generation of the particular application; identifying a set of stored mock application data associated with the particular application; incorporating at least a portion of the identified set of mock application data into a runtime version of the particular application; and executing the particular application using the incorporated set of mock application data in a validation environment.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect combinable with any of the previous aspects, the mock application data is stored in and used from a local JavaScript Object Notation (JSON) source.

In a second aspect combinable with any of the previous aspects, the particular application is defined using data models and templates.

In a third aspect combinable with any of the previous aspects, the mock application data corresponds to the data model of the particular application.

In a fourth aspect combinable with any of the previous aspects, the mock application data is specifically linked to the particular application or user interface.

In a fifth aspect combinable with any of the previous aspects, the mock application data is modified while the particular application is executed within the validation environment, wherein the particular application executes using the modified mock application data after the modification.

In a sixth aspect combinable with any of the previous aspects, the particular application is initially executed using the mock application data instead of productive data, and the method further comprises receiving a user selection of either the productive data or the set of mock application data to be used during execution of the particular application, linking the particular application to a data source of either the productive data or the set of mock application data based on the user selection; and executing the particular application using data from the linked data source.

In a seventh aspect combinable with any of the previous aspects, the method further includes sending the application to a software development system with a request to generate a set of connections to the backend systems in a production system in response to receiving approval of the application within the validation environment.

In an eighth aspect combinable with any of the previous aspects, the validation environment and mock application data are available for review using a preview service.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example environment for using mock application data to validate an application.

FIGS. 2A-2B show an example user interface for developing a user interface for a new application.

FIG. 2C is a block diagram of an example architecture for a system using mock application data to validate an application.

FIG. 3A is a flowchart of an example method for model binding.

FIG. 3B is a flowchart of an example method for using mock application data to validate a new application.

Like reference numbers and designations in the various drawings indicate like elements.

### DETAILED DESCRIPTION

This disclosure generally describes computer-implemented methods, software, and systems for using mock application data to validate an application. For example, a particular application to be validated is identified. The particular application is generated via a user interface for generating new applications. Also, the particular application is consistent with a data model used during the generation of the particular application. A set of stored mock application data associated with the particular application is identified. At least a portion of the identified set of mock application data is incorporated into a runtime version of the particular application. The particular application is executed using the incorporated set of mock application data in a validation environment.

An application design and development tool can be used for business users, designers and developers. The tool can include templates and components, which can enable rapid development of small, attractive applications, and easy access to data. By starting with the definition of the application interface, application creators can apply a design thinking approach to their project.

The application design and development tool can include a corresponding web server infrastructure, a repository for source and version management, and a groupware server, all of which can be located in the cloud. The application design and development tool user interface can be based, e.g., on HyperText Markup Language 5 (HTML5) and user interface components and can run in the browser on a desktop machine, mobile device, or other suitable system.

A content development process can follow a user interface (UI) first approach based on application and custom component templates which include predefined content and are delivered by a business application system. Based on these templates and basic controls, business applications can be built by the business users, UI designers, or even developers. The prototypes can be either simulated in a browser, with a phone and tablet emulation, or run instantly on a mobile phone or tablet, including structured and unstructured mock data. In addition, the visual design can be customized by a UI theme designer including background images, colors, and textures.

The final result of the specific application can be ready for hand-over as a project archive file to the development system for further execution, e.g., as a zip file that contains the HTML5, Java Script, CSS, EDMX2, including vocabulary, images, and other files. In particular the data service implementation and endpoint configuration can be provided by the local IT department.

The UI first approach, based on compositions of complex UI building blocks, free style basic controls, and other components, can result in custom-tailored and specific data sources which cannot be provided by predefined content delivered by a business application system. The probability that a single predefined service will match exactly the need of the user interface defined by this approach can be nearly zero. On the other hand, performance considerations can enforce minimization of round-trips and transported data between the backend and front-end applications, which can be optimally fulfilled by a single service interface from a single domain. In addition, the custom-tailored specific data source can be subject of authority constraints, which provides the ability to grant authorization for the tailored services exactly to those users using the consuming application.

Predefined services can be used without any kind of back-end service adaptation by the user. This can prevent the user from having to spend significant time on service discovery and model binding at the expense of time spent on UI design.

Furthermore, the security constraints and authority objects needed for the newly designed user interface application cannot be derived from the used building block templates and basic controls or defined by the policies of the user of the application designer who is creating the UI application.

These considerations can lead to the basic assumption that the specific service required by the user interface normally does not exist, but it can be possible to describe the needed specific service definition. This service definition can then be handed over to the development in the IT department. One negative consequence can be that, without any specific runtime services, is not clear how to provide any kind of mock data via the data service.

Applications can behave and look very different with realistic versus mock application data. The best applications are designed with a full and realistic data set from the start. Therefore, there exists a need to provide realistic mock data for all phases of application designer usage. Mock application data can be created by the user so that it can match a specific scenario, as well as the data model associated with the application to be tested.

Design issues and questions for describing these problems include, among others: 1) how to ensure performance and security requirements? 2) how to avoid complex model binding efforts in the tool? 3) how to create clear service definitions based on composition of UI building blocks? and 4) how to maintain and provide mock data for the UI prototypes?

The subject matter described in this specification can be implemented in particular implementations to realize one or more of the following advantages. First, mock application data can be developed simultaneously while developing a new application. Second, mock application data that is developed is automatically associated with a data model. Third, when validating a new application, the use of mock application data instead of productive data can be controlled with a single command or switch. Fourth, automatic binding of new applications and mock application data to data models eliminates the need for an application developer to learn complex aspects of the model binding, allowing the application developer to concentrate on the UI and the application. Fifth, developers can rapidly develop new applications that are automatically consistent with data models and mock application data.

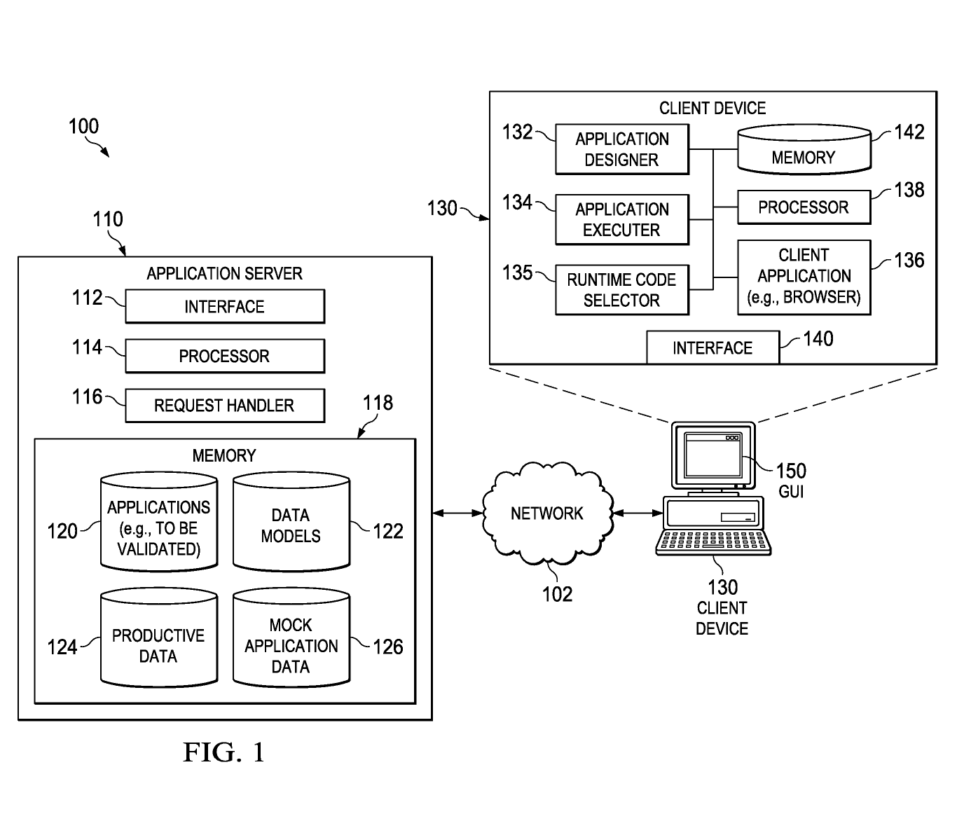

FIG. 1 illustrates an example environment 100 for using mock application data to validate an application. Specifically, the illustrated environment 100 includes at least one application server 110 and at least one client device 130, all of which are communicably coupled using a network 102. For example, a user interacting with a user interface presented on the client device 130 can develop new applications using application information and application data provided by the application server 110. The application data can include, for example, productive data and mock application data.

In some implementations, the environment 100 can be used to develop new applications using, for example, a user-interface-first approach. In this approach, the user interface for the application can be designed interactively using custom component templates that include or are associated with predefined content and that are based on business models.

As used in the present disclosure, the term “computer” is intended to encompass any suitable processing device. For example, although FIG. 1 illustrates a single application server 110, the environment 100 can be implemented using two or more application servers 110. The environment 100 can also be implemented using computers other than servers, including a server pool. Indeed, components of the environment 100 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated components of the environment 100 may be adapted to execute any operating system, including Linux, UNIX, Windows, Mac OS®, Java™, Android™, iOS or any other suitable operating system. According to some implementations, components of the environment 100 may also include, or be communicably coupled with, an e-mail server, a Web server, a caching server, a streaming data server, and/or other suitable server(s). In some implementations, components of the environment 100 may be distributed in different locations and coupled using the network 102.

The application server 110 includes an interface 112, a processor 114, a request handler 116, and a memory 118. The interface 112 is used by the application server 110 for communicating with other systems in a distributed environment, connected to the network 102 (e.g., the client device 130), as well as other systems (not illustrated) communicably coupled to the network 102. Generally, the interface 112 comprises logic encoded in software and/or hardware in a suitable combination and operable to communicate with the network 102. More specifically, the interface 112 may comprise software supporting one or more communication protocols associated with communications such that the network 102 or interface's hardware is operable to communicate physical signals within and outside of the illustrated environment 100.

The request handler 116, for example, can handle requests received from systems and/or devices external to the application server 110. For example, the request handler 116 can handle a request received from the client device 130, e.g., when a user using the client device is developing a new application, validating the new (or an existing) application, or at other times. Requests can include requests for applications (e.g., including their source code) and productive data or mock application data to be used in validating the applications. In response to the request, the request handler 116 can provide the requested information to the client device 130.

The application server 110 also includes the memory 118, or multiple memories 118. The memory 118 may include any type of memory or database module and may take the form of volatile and/or non-volatile memory including, without limitation, magnetic media, optical media, random access memory (RAM), read-only memory (ROM), removable media, or any other suitable local or remote memory component. The memory 118 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the application server 110. Additionally, the memory 118 may include any other appropriate data, such as VPN applications, firmware logs and policies, firewall policies, a security or access log, print or other reporting files, as well as others. In some implementations, memory 118 includes data stores, such as data stores 120-126 that include data used by the client device 130 in creating new applications and validating new and existing applications. Other components within the memory 118 are possible.

The data store of applications 120, for example, includes information identifying applications used in the environment 100 and that are to be validated (or that have already been validated). In some implementations, each of the applications can be identified by an application identifier and/or some other identifiers, including versions and/or other configuration control identifiers. The data store of applications 120 also includes, for each application, associated application code, such as source code, compiled code, and/or other states/formats of application code. Applications can include any type of computer software components, such as programs, drivers, configuration files, functions, subroutines, methods, scripts and other components.

The data store of data models 122, for example, includes information that corresponds to how data elements are designed, structured and used by applications within the environment 100, including the applications included in the data store of applications 120. The data models 122 can include, for example, information that identifies relationships among data elements, business rules associated with the data elements, requirements associated with business processes associated with the data elements, data types and allowable values for the data elements, and other data model-related information. The data models 122 can be consistent with business objects and business rules.

The data store of productive data 124, for example, includes data that is used in productive versions of applications. The use of the productive data can include creation, modification and deletion, or one or more data elements. Although indicated as part of the application server 110, productive data 124 can be distributed across plural application servers 110, client devices 130, and other locations. In some implementations, some or all of the productive data 124 can be stored at the application server 110 or remote from the application server 110. For example, some or all of the productive data 124 can be stored on the client device 130 or at one or more locations remote from the application server 110, and the client device 130, yet accessible over the network 102. Data sources of the productive data 124 can be switchable by the user. In some implementations, at least a portion of the productive data 124 may be managed, stored by, or otherwise held in the possession of a third-party, such that one or more remote connections to the productive data 124 may be needed to access the productive data 124.

The data store of mock application data 126, for example, includes data that is non-productive yet can be used to test and/or validate existing applications and new applications that may be created on the client device 130. The mock application data 126 is consistent with associated data models 122. A subset of mock application data 126 that is associated with one or more particular applications can be a starting state of mock application data, e.g., before modification occurs using the application being validated. In this way, each validation run of a particular application can start with a clean subset of mock application data. In some implementations, data elements of mock application data can each include a timestamp, so that rolling back to a particular version of mock application data can be accomplished by deleting data elements with timestamps after a certain date/time value. Some or all of the mock application data 126 can be stored at the application server 110 or on the client device 130, with the source being switchable by user settings. In some instances, those settings may be changed during runtime, allowing users to test the application with mock application data 126 initially. Once the application is approved or otherwise validated, the user may switch the system to the productive data 124, such that the application can be used in regular business or application. Mock application data is consistent from an operational business perspective so that it can be validated by business users in addition to technical developers.

Binding data models 122 to the application being developed can occur automatically. For example, applications (described in more detail below) can enforce aspects of the data models onto the application development process, e.g., to prevent development of a user interface, underlying application and mock application data 126 from being inconsistent with the data models. Data models themselves can be generated in different ways. For example, a data model can be generated as a by-product of developing a user interface, e.g., based on user selections in developing the user interface of a new application. In another example, a data model can be generated in a standalone environment and used later. In some instances, a portion of the data model can be generated automatically during the development of a user interface, with the availability of manual user modifications to further edit the automatically-generated data model.

The illustrated environment of FIG. 1 also includes the client device 130, or multiple client devices 130. The client device 130 may be any computing device operable to connect to, or communicate with, at least the application server 110 over the network 102 using a wire-line or wireless connection. In general, the client device 130 comprises an electronic computer device operable to receive, transmit, process, and store any appropriate data associated with the environment 100 of FIG. 1.

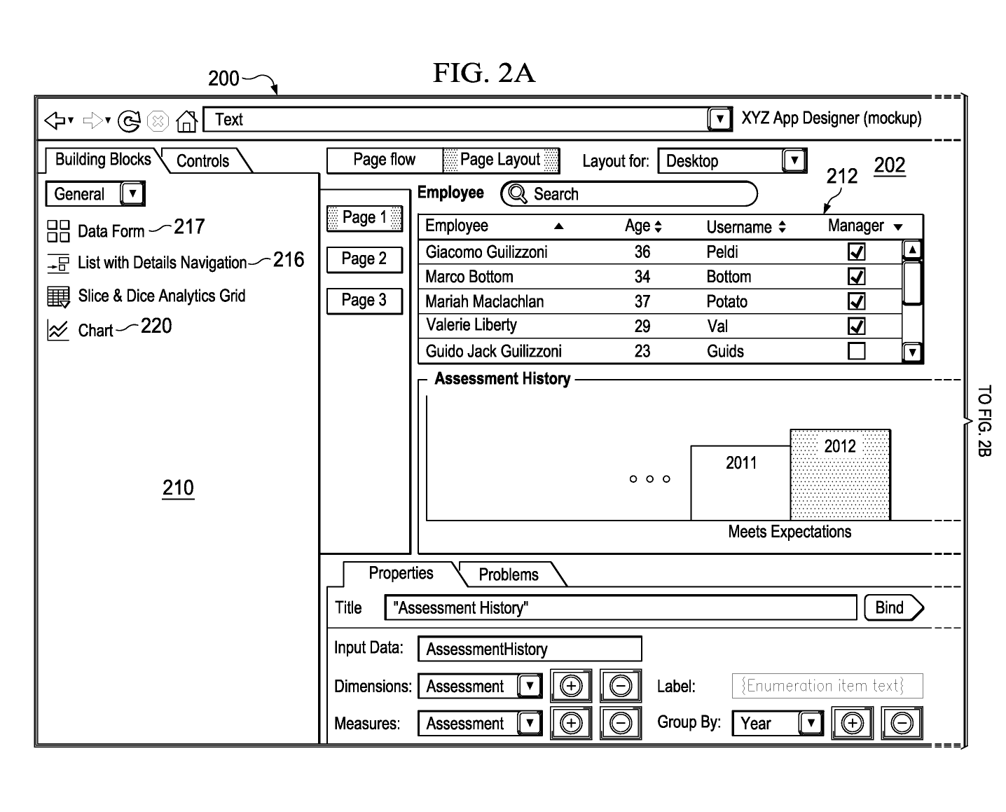

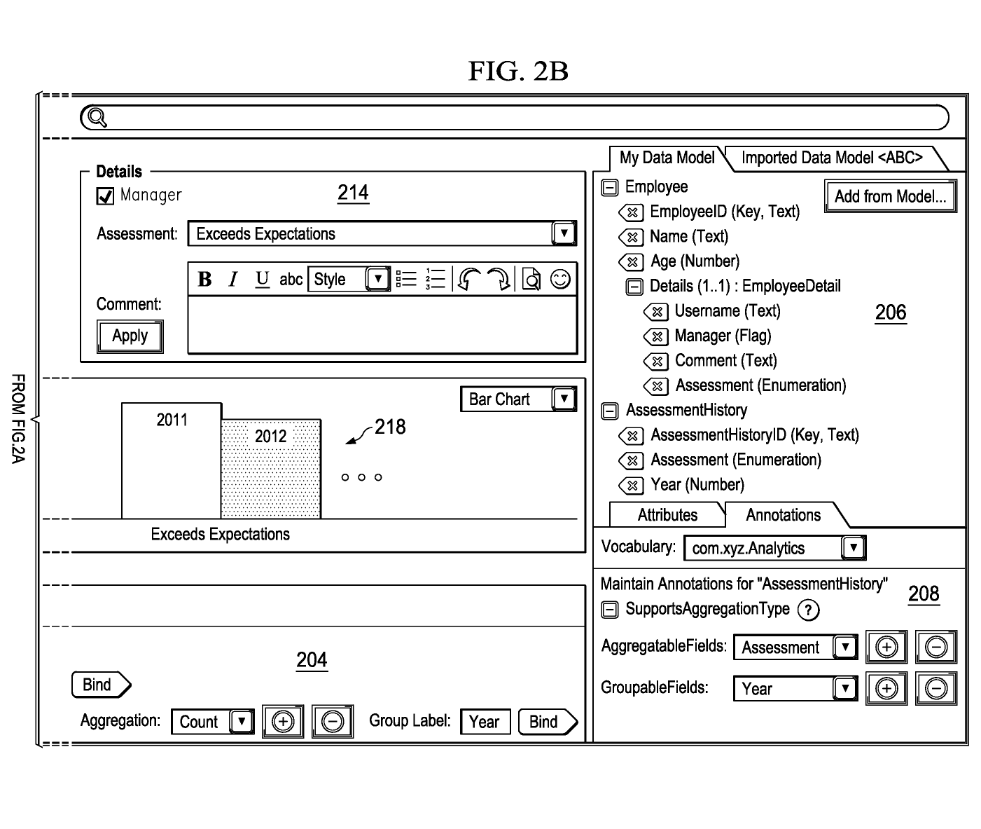

The illustrated client device 130 further includes an application designer 132 that can be used to design and develop a new application, e.g., by way of using tools and controls for designing the user interface (UI) for the application. As will be described in more detail with reference to FIGS. 2A-2B, the application designer 132 can include, for example, a page layout area for developing the UI, a building blocks area for selecting UI elements to drag and drop into the page layout area, a properties area for displaying properties associated with UI elements in the page layout area, a data model area for displaying and continuously updating a data model that corresponds to the UI being built, and an attributes area for displaying attributes associated with the data model. Other areas and features are possible.

The illustrated client device 130 further includes an application executor 134 for selecting an application to be executed. For example, controls can be included with the application executor 134 for identifying a particular application to be run and to specify whether the execution of the application is to use productive data 124 or mock application data 126.

The illustrated client device 130 further includes a runtime code selector 135 that accesses either the productive data 124 or the mock application data 126. The type of data selected at runtime during validation of a particular application can depend, for example, on a user selection of a control in the application executor 134. In some implementations, new applications can be set to use mock application data 126 until a time that they are validated and approved, at which time they can be switched to using the productive data 124. In some implementations, a decision of whether and when to switch to productive data can be based on signals provided by the application server 110. For example, the user devices 106 can be connected to the application server 110 for the purposes of testing and validating new applications, and the application server 110 can authorize switching to the productive data 124.

The illustrated client device 130 further includes at least one client application 136. The client application 136 can be any type of application that allows the client device 130 to request and view content on the client device 130. In some implementations, the client application 136 can include a Web browser or any other application that may display or use content. In some implementations, the client application 136 can use parameters, metadata, and other information received at launch to access a particular set of data received from the application server 110. Once a particular client application 136 is launched, a user may view and interact with content presented on the client device 130.

The illustrated client device 130 further includes an interface 140, a processor 138, and a memory 142. The interface 140 is used by the client device 130 for communicating with other systems in a distributed environment—including within the environment 100—connected to the network 102, e.g., the application server 110, as well as other systems communicably coupled to the network 102 (not illustrated). Generally, the interface 140 comprises logic encoded in software and/or hardware in a suitable combination and operable to communicate with the network 102. More specifically, the interface 140 may comprise software supporting one or more communication protocols associated with communications such that the network 102 or interface's hardware is operable to communicate physical signals within and outside of the illustrated environment 100.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including JavaScript™, Hyper-Text Mark-up Language (HTML), C, C++, Java™, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

As illustrated in FIG. 1, the client device 130 includes the processor 138. Although illustrated as the single processor 138 in FIG. 1, two or more processors 138 may be used according to particular needs, desires, or particular implementations of the environment 100. Each processor 138 may be or include a central processing unit (CPU), an application specific integrated circuit (ASIC), a field-programmable gate array (FPGA), or another suitable component. Generally, the processor 138 executes instructions and manipulates data to perform the operations of the client device 130. Specifically, the processor 138 executes the functionality required to send requests to, and process responses from, and the application server 110.

The illustrated client device 130 also includes a memory 142, or multiple memories 142. The memory 142 may include any memory or database module and may take the form of volatile or non-volatile memory including, without limitation, magnetic media, optical media, random access memory (RAM), read-only memory (ROM), removable media, or any other suitable local or remote memory component. The memory 142 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 130. Additionally, the memory 142 may include any other appropriate data, such as VPN applications, firmware logs and policies, firewall policies, a security or access log, print or other reporting files, as well as others.

The memory 142 can include copies of data, for example, obtained from (or pending storage to) the application server 110 or other sources. For example, if a new application is being developed on the client device, the memory 142 can include data model information associated with the new application that can be stored in the data models 122. In another example, the memory 142 can include productive data 124 and/or mock application data 126 being used to test or validate applications executing on the client device 130. In yet another example, the memory 142 can include mock application data that is being developed on the client device 130 and that is pending storage on the application server 110.

The illustrated client device 130 is intended to encompass any computing device such as a smart phone, tablet computing device, PDA, desktop computer, laptop/notebook computer, wireless data port, one or more processors within these devices, or any other suitable processing device. For example, the client device 130 may comprise a computer that includes an input device, such as a keypad, touch screen, or other device that can accept user information, and an output device that conveys information associated with the client device 130, including digital data, visual information, or a graphical user interface (GUI) 150, as shown with respect to and included by the client device 130. The GUI 150 interfaces with at least a portion of the environment 100 for any suitable purpose, including generating a visual representation of a Web browser and providing the UI for the application designer 132, e.g., to display information and receive user inputs for developing a particular new application and developing mock application data.

Each application project can “own” exactly one data source that adheres to data standards. The user can edit the data source arbitrarily, only restricted by data standards. Artifacts and terminology of the data source are based on data standards. Apart from a pure data model, vocabulary-based annotations are supported to enrich the model with additional (UI-relevant) metadata. Visualization of the data source may aggregate or hide data model service concepts for sake of simplicity (e.g., it may visually combine Entity Set and Entity Type artifacts by default).

Based on this data source, the user can maintain bindings to simple UI controls, as well as whole building blocks. Depending on the UI artifact to be bound, this can reach from assigning a single data model property (e.g., in case of an input field) to binding multiple related entity types in one action (e.g., for a list/details building block).

While binding data artifacts, supported annotations for these artifacts can also be taken into account. For example, assuming there is some UI data vocabulary containing a term “Label,” a correspondingly annotated data model property bound to a UI input field can automatically supply a label for this field at design time. Further, assuming that a UI will also understand this UI vocabulary, the label can also be taken over dynamically at runtime from the annotation, which will, for example, enable language-dependent provisioning of the label.

As a more sophisticated example, a UI building block for using analytical data can be considered. For example, annotations based on some “analytics” vocabulary supported by an application designer can be used to classify data model properties as dimension fields.

Apart from manually editing a data model being created, the user can also add (e.g., copy and paste) artifacts, such as entity types, complex types, and other elements from already existing data model services (including annotations, if available). Consequently, the application designer can allow for maintaining a list of catalog service destinations.

With respect to adding and binding UI controls, the following features can exist. In a feature that performs a drag-and-drop from a UI controls palette, the data model can be extended to provide a default binding for the newly added control, including annotations applicable to the control, e.g. a UI label for an input field as depicted above. If a control with predefined binding is added, the binding can be matched with the current content of a corresponding data source, such as a field in a UI screen. In a feature that performs a drag-and-drop from the data source to an empty canvas area, the application designer can interpret attached data model annotations to create an applicable UI control/building block. If there are multiple sensible alternatives for the control to be created, options can be displayed to the user to select of one of them. For a feature that performs a drag-and-drop from a data source to an already existing UI control, the application designer can propose a corresponding mapping, if feasible, or otherwise indicate that the drop target is invalid. A feature that edits parts of bound UI controls (e.g., field labels, columns of a table, etc.) can be reflected in the data source on-the-fly by adapting corresponding data model annotations, and adding/removing/renaming data model properties, etc. In a feature that edits binding expressions in UI control attributes explicitly, if referring to non-existing data source nodes, the application designer can ask if the user wants corresponding nodes to be created.

Upon finishing a first version of the UI and a corresponding data model, the user typically wants to test the application. At this stage, the data model can be translated into a private mock data service. For example, the mock application data can be used as a basis for generating a data service that adheres to the model. This can allow for further refining the model without being dependent on external service provisioning.

After reaching a certain level of confidence regarding the application, the user may want to test it against already existing data services (e.g., productive data) instead of mock application data only. The user can identify services that fit, or partially fit, the data source (e.g., a data field in a UI), e.g., anything that cannot be covered by existing services can still be mock application data, based in this phase. To facilitate discovery of appropriate services, matching the data source with data catalog content can be supported. As a first step, entity type names from the data source can be used for a tag-based search. Services found this way can then further be compared to the data source structure to enhance the search result precision.

As a final step to produce a productive high-performance application, a tailored data service can be provided, in most cases, as the combination of already existing services. To support that, the application designer can allow for exporting the data source model as a data service description for handover to a service provisioning development.

Templates and data model interface can be defined. Specific application and building block templates can provide predefined bindings to best-practice data source models that can be matched together for delivered or at least realistic data model services. The data source model can be created on the fly and without specific business model knowledge or awareness of any backend constraints. The changes in the UI can result in changes to the application project specific data source, with the option that data source nodes are only marked as unbound or to-be-deleted when deleting bound UI controls (and vice versa). Apart from that, this ad-hoc change paradigm can include adequate undo and redo functionality. Exports (e.g., using zip files) of data model information can include XML and Java Script files, CSS files, images, and data model service descriptions derived from the data source including data models and corresponding UI binding data.

FIGS. 2A-2B show an example user interface 200 for developing a user interface for a new application. For example, the user interface 200 can be part of the application designer 132 described above, such as to design the UI for a new application. Development of the new application can include, for example, the definition of mock application data that can be used to populate fields and other spaces on the user interface 200, as well as the dynamic creation of a data model bound to the design UI.

The user interface 200 includes, for example, a page layout area 202 for developing the UI. In this example, the page layout area 202 shows an employee-related application (and its user interface) being developed, e.g., including a list 212 listing employees and an associated details area 214 for listing details for a particular one of the employees. In some implementations, empty or data-populated versions of the list 212 and details area 214 can be added to the page layout area 202 by using a drag-and-drop operation, e.g., using corresponding elements from a building blocks area 210 for selecting UI elements to drag and drop into the page layout area 202. In the example shown in FIGS. 2A-2B, the list 212 and details area 214 can be added to the page layout area 202 using a list with details navigation element 216 that is dragged and dropped from the building blocks area 210. Other selection techniques can be used. In another example, a chart 218 in the page layout area 202 can be added to the UI of the application being developed using a drag-and-drop operation on a chart element 220 from the building blocks area 210. In addition to UI-related elements (e.g., controls) selected from the building blocks area 210, other drag-and-drop operations can be used. For example, drag-and-drop elements from a data source to an empty location on the page layout area 202 can create an element in the UI that includes data (e.g., mock application data). In another example, drag-and-drop elements from a data source to an existing element on the page layout area 202 can be used to populate the UI element with data.

The user interface 200 also includes a properties area 204 for displaying and accepting user inputs for properties associated with UI elements in the page layout area 202. In the example shown, property-related fields, controls and other elements in the properties area 204 correspond to the chart 218 (e.g., related to assessment history). Properties and other settings and selections by the user can be used, for example, to control the appearance and underlying data (e.g., what data is selected and how) that supports the generation of the chart 218.

The user interface 200 also includes a data model area 206 for displaying and continuously and dynamically updating a data model that corresponds to elements in the UI being built in the page layout area 202. For example, based on selections of UI elements related to employees, the data model area 206 can be automatically updated to reflect an underlying data model associated with the page layout area 202 and corresponding new application. The user can make changes to the data model, e.g., by using controls available in the data model area 206. Further, while the data model is being generated automatically, a narrative area (not shown) can be overlaid on or adjacent to the page layout area 202. For example, the narrative can provide a step-by-step explanation of how specific aspects of the data model are derived. The data model area 206 can present elements in ways that can help the user understand individual elements. For example, indentation among data model elements can be used to indicate hierarchical relationships among the elements. Also, cardinality numbers (e.g., 1:1, 1:N, etc.) can be used to indicate the number of subordinate/child elements under a parent element. Further, notations can be added to elements in the data model to identify which elements are key elements and what the elements' data types are (e.g., text, numeric, flag, enumeration or other types). Other displays, controls, data types and other aspects for elements in the data model can be used.

The user interface 200 also includes an attributes area 208 for displaying attributes associated with the data model. For example, the attributes area 208 can be used to define names of fields, valid ranges for numeric values or enumeration values in fields, and for other purposes. This can include, for example, attributes and other information for the employee-related fields that are part of the data model associated with the employee-related user interface being developed in the page layout area 202 for the new employee-related application.

A multi-step example follows that shows how a data model can be updated automatically, e.g., based on actions that occur in the page layout 202. This is also an example of model binding, as the data model is kept consistent with the UI being developed.

For example, an intermediate state of the data model (and the data model area 206) can exist after various user actions. The actions can include, for example, adding the list with details navigation element 216 to the page layout 202, maintaining a title and column headers that are included with the table, manually entering some sample lines into the table, and choosing “Checkbox” as a display type of the “Manager” column. As a result, in this intermediate state of the data model, for example, the data model area 206 can include:

```
Employee
  EmployeeID (ID)
  Name (Text)
  Age (Number)
  Username (Text)
  Manager (Flag)
    Details (1..1) : EmployeeDetail
```

Continuing with the example, a different and subsequent intermediate state of the data model (and the data model area 206) can exist after additional user actions. The actions can include, for example, adding a data form element 217 to the so-far-empty details area of the previously added list with details navigation element, dragging the existing “Manager” data model node into it (which can bind the node to the building block), and adding UI controls for “Assessment” and “Comment UI” afterwards (which can automatically create and bind the corresponding data model nodes). “Assessment” combo box entries have been manually maintained, defining an enumeration type for the automatically-generated “assessment” node. As a result, in this intermediate state of the data model, for example, the data model area 206 can include:

```
Employee
  EmployeeID (ID)
  Name (Text)
  Age (Number)
  Username (Text)
    Details (1..1) : EmployeeDetail
      Manager (Flag)
      Assessment (Enumeration)
      Comment (Text)
```

A final state of the data model area 206, for example, is shown in FIGS. 2A-2B. This state is achieved, for example, after adding a chart element 220 with the title “Assessment History” (which can automatically generate an “AssessmentHistory” node), and copying the node “Assessment” from “EmployeeDetail” to “AssessmentHistory.” An “Input Data” property of the chart element 220 can be already set to “AssessmentHistory” by default. “Dimensions,” “Measures,” “Group By” and other properties have also been manually maintained afterwards, further auto-enhancing the “AssessmentHistory” node with “Year” as well as setting Analytical annotations (e.g., “AggregatableProperties” and “GroupableProperties).

FIG. 2C is a block diagram of an example architecture 230 for a system using mock application data at runtime to validate an application. The architecture 230 includes at least one desktop component 232 and a server component 234. In some implementations, the desktop component 232 can correspond, for example, to applications that execute on the client device 130, such as the application designer 132 that can include the user interface 200. The server component 234 can correspond to, for example, the application server 110. The server component 234 can interact with other components in the example architecture 230, such as a repository 236 and groupware 238.

In some implementations, the desktop component 232 includes a browser 240 that can execute an application designer 241 (e.g., the application designer 132). The application designer 241 includes a plurality of modules, e.g., a view designer 242 using at least one UI model 244, together providing functionality that can be presented by an editor of the page layout area 202. A model editor 246 that interfaces with a plurality of model definitions 248 can provide functionality that controls at least the data model area 206. A mock data editor 250 that interfaces with mock data 252 can provide functionality that controls the input and/or editing of mock application data that can be used to validate a new application being developed. For example, the mock data 252 can include the mock application data 126.

The server component 234 includes a request handler 452 (e.g., the request handler 116) that handles requests received from the desktop component(s) 232. The requests can include, for example, requests for UI elements (e.g., requests for elements 216 and 220 from the building blocks area 210). The request handler 254 can also handle requests for an application designer controller 258 (e.g., that primarily controls the application designer 132) and a preview service 260, e.g., that prepares what the developer sees when developing an application.

The application designer controller 258 includes a theme designer 262 and a UI designer 264, e.g., for designing new applications. The application designer controller 258 can invoke a template service 266 to access templates 268, e.g., to provide templates for use in the page layout area 202. In some instances, the templates 268 may be associated with at least a portion of a predefined data model or model definition 248. The application designer controller 258 can access workspace information 270 and mock data 272, e.g., that includes mock application data 126.

Components of the application designer controller 258 use a repository client 274 and a groupware client 276 to access the repository 236 and groupware 238, respectively. Access to information in the repository 236 can be controlled by a repository manager 278 that provides access to user and policies information 280 and project information 282. Access to information in the groupware 238 can be controlled by a groupware manager 284 that provides access to groupware user and policies information 286 and content 288.

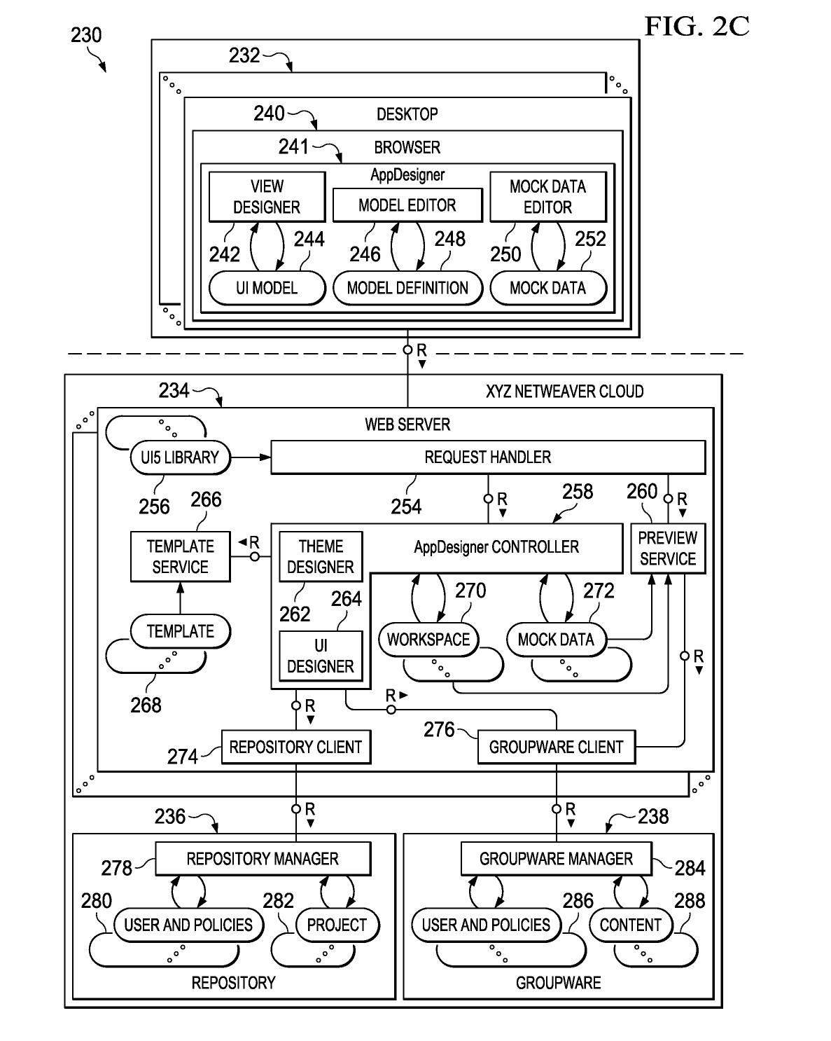

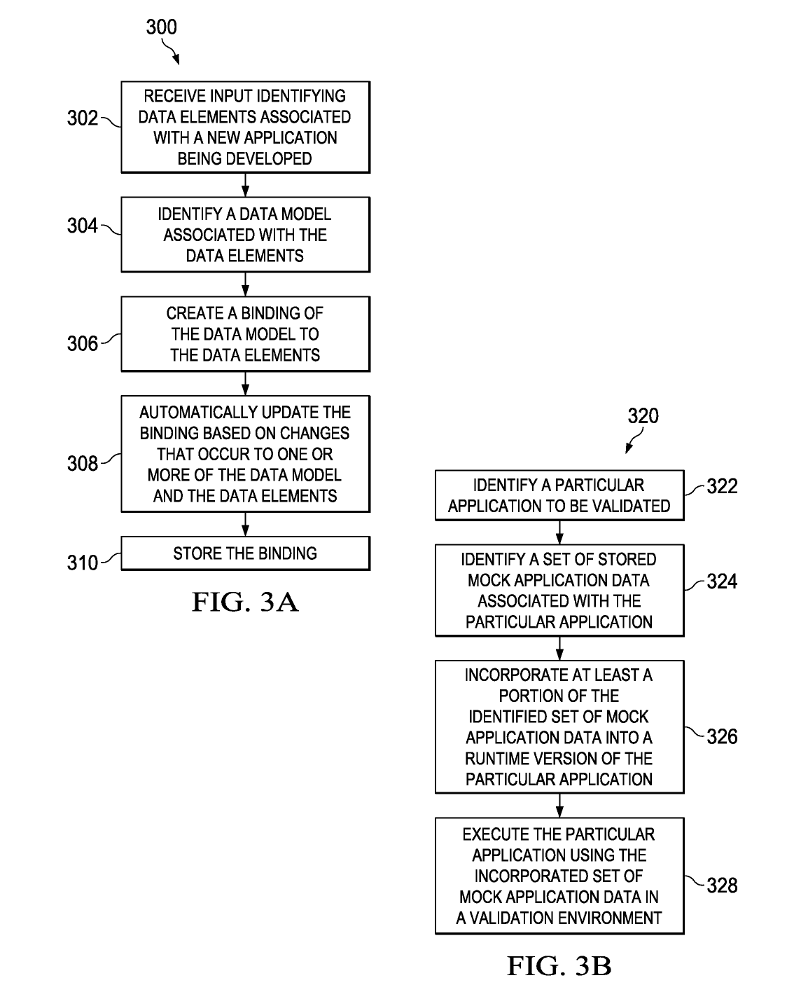

FIG. 3A is a flowchart of an example method 300 for model binding. For clarity of presentation, the description that follows generally describes method 300 in the context of any of FIGS. 1 through 2B. However, it will be understood that the method 300 can be performed, for example, by any other suitable system, environment, software, and hardware, or a combination of systems, environments, software, and hardware as appropriate. For example, the client device 130 and/or its components can be used to execute the method 300, e.g., using information accessed from the application server 110.

At 302, input is received identifying data elements associated with a new application being developed. For example, the identified data elements can include new data fields being added to the user interface 200 while a new application is being developed. Specifically, the new data elements can correspond to new elements added to or modified in the page layout area 202. In another example, the identified data elements can include mock application data associated with a new application is being developed, e.g., in the user interface 200.

At 304, a data model associated with the data elements is identified. For example, if an employee-related data field is added to the page layout area 202, a data model corresponding to that employee-related data field can be identified.

At 306, a binding of the data model to the data elements. For example, the application designer 132 can bind the data model associated with the data model area 206 with elements in the page layout area 202.

At 308, the binding is automatically updated based on changes that occur to one or more of the data model and the data elements. For example, the model changes, then the changes are automatically applied to data elements such as elements in the user interface for the new application and any associated mock data.

At 310, the binding is stored. For example, the application designer 132 can store the binding information with the application, e.g., in the applications 120.

FIG. 3B is a flowchart of an example method 320 for using mock application data to validate an application. For clarity of presentation, the description that follows generally describes method 320 in the context of any of FIGS. 1 through 2B. However, it will be understood that the method 320 can be performed, for example, by any other suitable system, environment, software, and hardware, or a combination of systems, environments, software, and hardware as appropriate. For example, the client device 130 and/or its components can be used to execute the method 320, e.g., using information accessed from the application server 110.

At 322, a particular application to be validated is identified (e.g., including identifying a particular universal resource locator (URL) associated with the particular application). The particular application is generated via a user interface for generating new applications, and the particular application is consistent with a data model used and/or defined during the generation of the particular application. For example, a user using the user interface 200 can specify (e.g., using a control) that the application being developed using the user interface 200 is to be validated. The user selection, for example, can be handled by the application designer 132 which can identify the application using a URL. If the application is not already on the client device 130, for example, a request (that includes an identifying URL of the application) can be sent by the application designer 132 to the application server 110 to retrieve the particular application, e.g., from the applications 120. The application that is selected for validation may currently be, or has been, under development using the application designer 132. Also, the development of the application is consistent with data models 122 or a data model being developed in tandem with the application.

In some implementations, the particular application is defined using data models and templates. For example, the application can be the employee-related application described above with reference to FIGS. 2A-2B that uses models and templates available from the user interface 200.

At 324, a set of stored mock application data associated with the particular application is identified. For example, while developing the application, the user can simultaneously develop mock application data to be used in validating the application. In another example, during use of the user interface 200, the user can provide inputs that identify particular mock application data to be used. Other screens (not shown) can be used to create mock application data.

In some implementations, the mock application data is stored in and used from a local JavaScript Object Notation (JSON) source. For example, mock application data that is generated on the client device 130 or retrieved from the application server 110 can be stored locally in a local JSON source, e.g., in memory 142 for use in validating the application.

In some implementations, the mock application data corresponds to the data model of the particular application. As an example, the mock application data that is used to validate a particular application can be consistent with data model information displayed in the data model area 206 that corresponds to the particular application being developed.

In some implementations, the mock application data is specifically linked to the particular application or user interface. For example, using controls associated with the application designer 132, the user can associate a particular set of mock application data with an application. The association can be stored, for example, with the applications 120.

At 326, at least a portion of the identified set of mock application data is incorporated into a runtime version of the particular application. As an example, when the particular application is prepared for execution by the application executor 134, the runtime code selector 135 can automatically incorporate (or otherwise make available) applicable mock application data for the execution of the application.

At 328, the particular application is executed using the incorporated set of mock application data in a validation environment. For example, the application executor 134 can execute the program using the mock application data identified for execution.

In some implementations, the mock application data is modified while the particular application is executed within the validation environment, wherein the particular application executes using the modified mock application data after the modification.

In some implementations, the particular application is executed using the mock application data instead of productive data, and the method 320 further includes additional steps using the mock application data. A user selection is received that selects either the productive data or the set of mock application data to be used during execution of the particular application. The particular application is linked to a data source of either the productive data or the set of mock application data based on the user selection. The particular application is executed using data from the linked data source.

In some implementations, the validation environment and mock application data are available for review using a preview service. For example, the application designer 132 and/or other related applications can include functions and/or features that allow the user to monitor the validation process and review mock application data before, during and after the validation. For example, the mock application data can be edited using the application designer 132 and/or other interfaces. The mock application data can be stored as one or more source files or other files and/or structures in a corresponding project repository when the project is saved. When a user interface application is launched as an application for testing purposes, the required mock application data can be deployed through the network and available as needed, e.g., in a preview service. The preview service can simulate the needed data service by providing exactly the same interface (e.g., entity model as needed by the application) and mock application data.

In some implementations, the method 320 further includes sending the application to a software development system with a request to generate a set of connections to the backend systems in a production system in response to receiving approval of the application within the validation environment. For example, once the particular application is validated, e.g., including an approval by the user or an approving authority, the user can use controls and/or options available from the application designer 132 to set the application into production. This can include configuration control and other software controls that provide provisions for allowing the application to be installed and used in a productive environment.

In some implementations, applications can be provided that allow the user to define application templates and building block templates which provide entity data model definitions, including the binding of the entities to the corresponding user interface controls. For example, the user interface 200 or other such user interfaces can allow the definition of templates that are used in the user interface 200, e.g., during development of a new application.

In some implementations, the application designer 132 or other application(s) can include controls and functionality for exporting data model definitions. For example, the exported data models can be provided over the network 102, in a zip file, or in other ways.

In some implementations, user interface applications can be created using external data sources. For example, data sources other than the applications 120, the data models 122, the productive data 124 and the mock application data 126 can be used.

In some implementations, tool sets can be provided that define ready-to-use application templates and building block templates which provide mock application data for each building block including simple text, code lists, and images. For example, applications that provide the environment 100, including the application designer 132 can be provided commercially to external parties.

In some implementations, tools can be provided for use by a business user or UI/application designer to change and/or create additional mock application data. For example, mock application data can be created for various portions of applications, such as mock application data for basic controls, including simple text, code lists, and images.

In some implementations, mock application data can be used without a connection to the application server. For example, mock application data can be local to the client device 130.

In some implementations, user interface applications such as the designer application 132 can be used without any security and authorization related constraints. For example, security compliance and authorization models can be defined by the developer during the implementation phase.

In some implementations, end users can use their own terminology for expressing the names of data types for the mock application data. For example, the user-assigned names need not be a simple reflection of the primitive data type names for text, number, date, time, indicator, image, attachment, and other data types.

In some implementations, editors for data model and mock application data can support user-specification of entity relationships. For example, users can define relationships such as 1:1, 1:N, and other relationships between nodes in a structure.

In some implementations, automatic identification of keys can occur for entities in a data model. For example, rather than relying on the user to identify the fields or elements which are to be used as keys, the designation of keys can be proposed based on signals such as which columns are fixed in a table view. When key selection cannot be made automatically, the user can be notified to set the keys manually. Once a key is identified, selecting values for the key can be automatic and invisible to the user.

In some implementations, tools can be provided that allow the input and modification of mock application in a table view. For example, the user can use spreadsheets and/or table commands/functions to set up multiple entries and/or to perform mass operations on the entries (e.g., add, modify, delete). Defaults for table entries can be of the type string, but can allow the user to override the type.

In some implementations, the initial data type of any mock application data entry shall be string or plain text. As long as the data type remains of type string, the user can enter any data. Upon the first entry of a value which is apparently of another type (e.g., a formatted number or a date), a dialog can ask the user whether the type should be changed. If the user makes a change to a type that will cause the loss of data, the user can be notified before the change is applied.

In some implementations, the mock application data can be provided in different ways. For example, the mock application data can be provided through a data service or accessed via a data model in the generated application. Some possible options for providing mock application data include providing mock application data in a browser (e.g., as local Java Script/JSON source backing the data model), and using a mock data service hosted on a server. In some implementations, multiple ways can be used.

In some implementations, some mock application data that is visible to users may not be auto-generated because of a high complexity of functionality, e.g., due to complexities in type, field length limits, what may or may not appear meaningful to a user, or for other reasons.

In some implementations, user interfaces can support undo and redo functions for changes, e.g., especially for operations performed automatically by the system for UI or data model modifications which can be more complex operations.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, example environment 100 may use processes with additional, fewer and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method comprising:
identifying a particular application to be validated, wherein the particular application is generated via a user interface for generating new applications, and wherein the particular application is consistent with a data model used during the generation of the particular application;
identifying a set of stored mock application data associated with the particular application;
incorporating at least a portion of the identified set of mock application data into a runtime version of the particular application; and
executing the particular application using the incorporated set of mock application data in a validation environment.

2. The method of claim 1, wherein the mock application data is stored in and used from a local JavaScript Object Notation (JSON) source.

3. The method of claim 1, wherein the particular application is defined using data models and templates.

4. The method of claim 1, wherein the mock application data corresponds to the data model of the particular application.

5. The method of claim 1, wherein the mock application data is specifically linked to the particular application or user interface.

6. The method of claim 1, wherein the mock application data is modified while the particular application is executed within the validation environment, wherein the particular application executes using the modified mock application data after the modification.

7. The method of claim 1, wherein the particular application is initially executed using the mock application data instead of productive data, and wherein the method further comprises:
receiving a user selection of either the productive data or the set of mock application data to be used during execution of the particular application;
linking the particular application to a data source of either the productive data or the set of mock application data based on the user selection; and
executing the particular application using data from the linked data source.

8. The method of claim 1, further comprising sending the application to a software development system with a request to generate a set of connections to the backend systems in a production system in response to receiving approval of the application within the validation environment.

9. The method of claim 1, wherein the validation environment and mock application data are available for review using a preview service.

10. The method of claim 1, wherein the mock application data is similar to productive data in type, format and data consistency, and wherein the mock application data is meant for imitation of the productive data for use in testing and validating applications.

11. A computer-program product, the computer program product comprising computer-readable instructions embodied on tangible, non-transitory media, the instructions operable when executed by at least one computer to:
identify a particular universal resource locator associated with a particular application to be validated, wherein the particular application is generated via a user interface for generating new applications, and wherein the particular application is consistent with a data model used during the generation of the particular application;
identify a set of stored mock application data associated with the particular application;
incorporate at least a portion of the identified set of mock application data into a runtime version of the particular application; and
execute the particular application using the incorporated set of mock application data in a validation environment.

12. The computer-program product of claim 11, wherein the mock application data is stored in and used from a local JavaScript Object Notation (JSON) source.

13. The computer-program product of claim 11, wherein the particular application is defined using data models and templates.

14. The computer-program product of claim 11, wherein the mock application data corresponds to the data model of the particular application.

15. The computer-program product of claim 11, wherein the mock application data is specifically linked to the particular application or user interface.

16. A system, comprising:
memory operable to store content, including static and dynamic content; and
at least one hardware processor interoperably coupled to the memory and operable to perform instructions to:
identify a particular universal resource locator associated with a particular application to be validated, wherein the particular application is generated via a user interface for generating new applications, and wherein the particular application is consistent with a data model used during the generation of the particular application;
identify a set of stored mock application data associated with the particular application;
incorporate at least a portion of the identified set of mock application data into a runtime version of the particular application; and
execute the particular application using the incorporated set of mock application data in a validation environment.

17. The system of claim 16, wherein the mock application data is stored in and used from a local JavaScript Object Notation (JSON) source.

18. The system of claim 16, wherein the particular application is defined using data models and templates.

19. The system of claim 16, wherein the mock application data corresponds to the data model of the particular application.

20. The system of claim 16, wherein the mock application data is specifically linked to the particular application or user interface.
